(19) United States
(12) Patent Application Publication
(10) Pub. No.: US 2004/0041965 A1
(43) Pub. Date: Mar. 4, 2004

(54) Transflector with a high gain of light efficiency for a liquid crystal display

(76) Inventor: Hong-Da Liu, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,571

(22) Filed: Sep. 4, 2002

(51) Int. Cl. G02F 1/1335

(52) U.S. Cl. 349/113

(57) ABSTRACT

Disclosed is a transflector with a high gain of light efficiency for an LCD including a bottom plate and an upper plate with a liquid crystal layer inserted therebetween. The transflector is arranged on the bottom plate side and comprises a transmissive region and a reflective region. To improve the gain of light efficiency for the LCD, the transflector is provided with a micro optical apparatus to gather the backlights to the transmissive region.

### BACKGROUND OF THE INVENTION

1. Field of the Invention

The present invention relates generally to a liquid crystal display (LCD), and more particularly to a transflector of an LCD.

2. Description of Related Art

LCDs are conventionally identified with two types, i.e., reflective LCD and transmissive LCD. A reflective LCD displays images by a reflector thereof to reflect the ambient light in front of the LCD that passes through the liquid crystal thereof to reach the reflector, the display performane is thus degraded when the enviroment is not bright enough for clear images. On the other hand, a transmissive LCD can overcome the problem resulted from the weak ambient light by introduction of a backlight source behind the liquid crystal. However, the backlight source consumes additional electric power and is disadvantagable to reduce the size and weight of the LCD system. A new type of LCD called transflective or partially reflective LCD provides both display modes of reflection and transmission for more flexable applications. When the enviroment is dark or not bright enough, the backlight source in a transflective LCD is turned on to provide enough illuminant, and on the other hand, turned off to save electric power when the enviroment is bright. To provide both display modes of reflection and transmission, a transflective LCD is equipped with a transflector thereof. FIG. 1 shows, for example, a typical transflector 12 on a transparent substrate 10 in a transflective LCD, which includes a reflective region 12a for the reflective display mode and a transmissive region 12b with an opening w for the transmissive display mode, respectively. The reflective region 12a reflects the frontlight when the LCD is operated in reflective display mode, and the transmissive region 12b permits the backlight to pass through the transflector 12 when the LCD is operated in transmissive display mode. However, the apparatus 12 induces a new problem of optical performane. For a transflective LCD to be oprated in either reflective display mode or transmissive display mode, part of the transflector 12 is reflective and the other is transmissive. As a result, the reflected light for the image display in reflective display mode is reduced due to the reduced reflective area and the usage of backlight in transmissive display mode is low since the backlight 14 behind the reflective region 12a is blocked by the reflective region 12a and only the backlight 16 behind the transmissive region 12b is provided for image disply. Therefore, the optical performane of both reflective display mode and transmissive display mode are degraded due to the reduced usage of light. Under considertion of the optical performance in reflective display mode, the transmissive region 12b of the transflector 12 for a transflective LCD cannot be too large, and has a typical opening ratio of about 15-40% for a transflector in practice. As a result, the backlight for the most part is wasted.

### SUMMARY OF THE INVENTION

One object of the present invention is to provide a transflector with a high gain of light efficiency for a transflective LCD to improve the transmissive display mode thereof.

Another object of the present invention is to provide a transflector with a high gain of light efficiency for a transflective LCD to improve the reflective display mode thereof.

Yet another object of the present invention is to svae the electric power consumption of the backlight source for a transflective LCD in addition to better optical performane.

In a transflective LCD including a bottom plate and an upper plate with a liquid crystal therebetween, according to the present invention, a transflector is arranged on the bottom plate side and includes a reflective region and a transmissive region with a micro optical apparatus to gather the backlight to the transmissive region of the transflector. Thereby the gain of light efficiency for such optical arrangment is increased up to 120-400% or more, and the electric power consumption of the backlight source is also economized.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a typical transflector for a conventional LCD;

FIG. 2 shows the first embodiment transflector according to the present invention;

FIG. 3 shows an embodiment arrangement of a TFT for the transflector of FIG. 2;

FIG. 4 shows another embodiment arrangement of a TFT for the transflector of FIG. 2;

FIG. 5 shows the second embodiment transflector according to the present invention;

FIG. 6 shows the third embodiment transflector according to the present invention;

FIG. 7 shows the fourth embodiment transflector according to the present invention;

FIG. 8 shows the fifth embodiment transflector according to the present invention;

FIG. 9 shows the sixth embodiment transflector according to the present invention;

FIG. 10 shows the seventh embodiment transflector according to the present invention, and FIG. 10A shows an alternative arrangement of which the micro optical apparatus to gather the backlight to the transmissive region is a film or plate attached to the LCD cell;

FIG. 11 shows an embodiment arrangement of a TFT for the transflector of FIG. 10;

FIG. 12 shows an embodiment micro lens structure according to the present invention, among which FIGS. 12A and 12B are the cross-sectional views of the micro lens in two crossover directions and FIG. 12C is the contour map of the micro lens;

FIG. 13 shows another embodiment micro lens structure according to the present invention, among whick FIGS. 13A and 13B are the cross-sectional views of the micro lens in two crossover directions and FIG. 13C is the contour map of the micro lens;

FIG. 14 shows an embodiment arrangement of the transmissive region of the transflector according to the present invention, and FIG. 14A is the contour map of the micro lens thereof;

FIG. 15 shows another embodiment arrangement of the transmissive region of the transflector according to the present invention, and FIG. 15A is the contour map of the micro lens thereof;

FIG. 16 shows an embodiment process to form the transflector according to the present invention, of which FIG. 16A is the cross-sectional view after coating a positive photoresistor 18 on a substrate 10, FIG. 16B is the cross-sectional view after transferring a pattern of micro lens with a mask 46, FIG. 16C is the cross-sectional view of the micro lens 18 after middle baking, FIG. 16D is the cross-sectional view of the micro lens 18 after hard baking, FIG. 16E is the cross-sectional view after deposition of an over coating 20, FIG. 16F is the cross-sectional view after deposition of an ITO 22, FIG. 16G is the cross-sectional view after transferring a pattern of diffusive layer with a mask 48, FIG. 16H is the cross-sectional view after forming a diffusive layer 24, and FIG. 16I is the cross-sectional view after deposition of a reflective layer 26 on the diffusive layer 24;

FIG. 17 shows the profile in X-direction of the micro lens 18 during the process of FIG. 16, of which FIG. 17A is the profile of the micro lens 18 before middle baking, FIG. 17B is the profile of the micro lens 18 after middle baking, and FIG. 17C is the profile of the micro lens 18 after hard baking; and

FIG. 18 shows the profile in Y-direction of the micro lens 18 during the process of FIG. 16, of which FIG. 18A is the profile of the micro lens 18 before middle baking, FIG. 18B is the profile of the micro lens 18 after middle baking, and FIG. 18C is the profile of the micro lens 18 after hard baking.

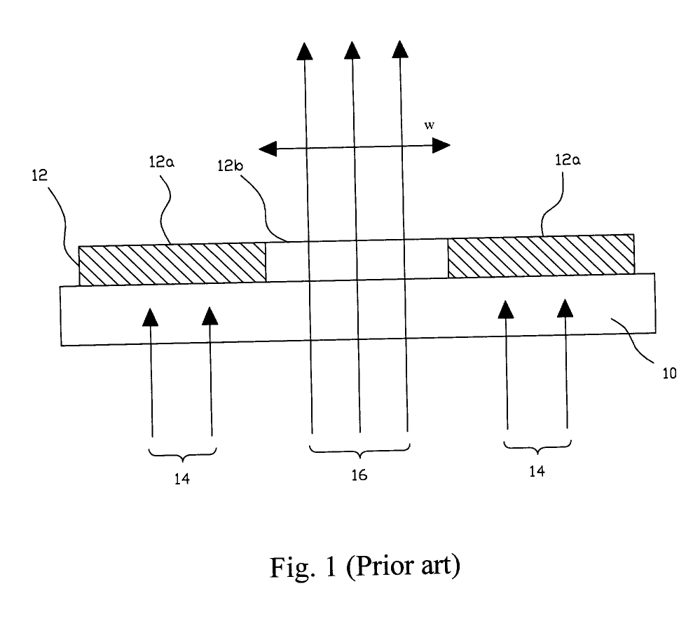

### DETAILED DESCRIPTION OF THE INVENTION

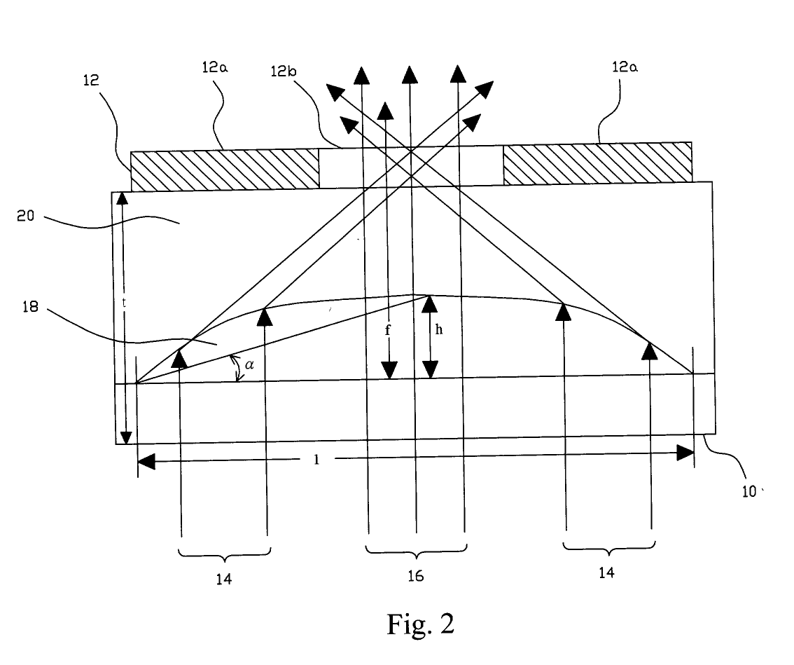

FIG. 2 shows the first embodiment transflector according to the present invention. Between a substrate 10 and a transflector 12 is arrange a micro lens 18 on which is covered with an over coating 20. The refractive index n_{L} of the micro lens 18 is 1.4-2.5, and the refractive index n_{C} of the over coating 20 is under the condition of |n_{L}−n_{C}|≧0.02. The micro lens 18 gathers the backlight 14 and 16 to be projected to the transmissive region 12b. It is noted that the backlight 14 behind the reflective region 12a formerly unable to be directly projected to the transmissive region 12b is now used for image display and thus improves the gain of light efficiency thereof. As is well known in the art, an LCD includes an upper plate and a bottom plate inserted with a liquid crystal therebetween, of which the bottom plate has active or passive switching elements thereof, such as thin film transistors (TFT) and diodes. Hereinafter the substrate 10 refers to the bottom plate and, furthermore, above the transflector 12 there are a liquid crystal and an upper plate that are also well known in the art and not illustrated in details in the drawings. The transflector 12 can be formed by deposition of a metal and selectively etching the metal. In the apparatus of FIG. 2, the micro lens 18 has a width l and a height h of 2-10 μm in the middle of the micro lens 18 to have h/l of 0.02-0.3. The average elevation angle α from the edge to the central top surface of the micro lens 18 is 1-2.5 degrees. The micro lens 18 has an average focus length f, and the over coating 20 has a thickness t of 2-16 μm to have f/t of 0.8-1.3. As is well known in the art, a cell gap refers to the thickness of the liquid crystal layer between the upper plate and the bottom plate. In this embodiment the average cell gap d_{T} of the transmissive region 12b equals to the average cell gap d_{R} of the reflective region 12a since the transflector 12 is a flat plate on the over coating 20.

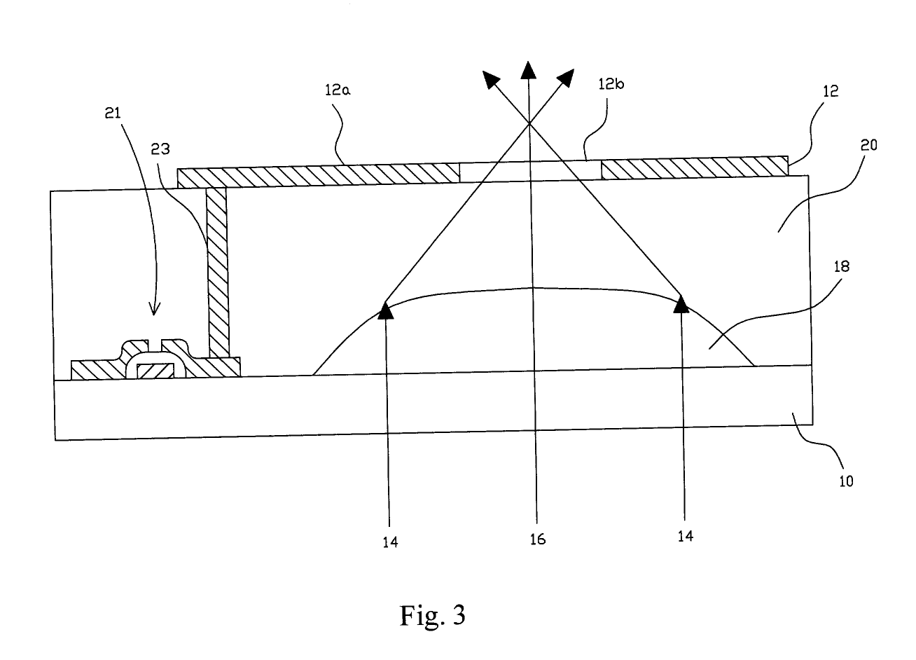

FIG. 3 shows an embodiment arrangement of a TFT for the transflector of FIG. 2, in which the TFT 21 is formed on the substrate 10 and covered by the over coating 20 as same as the micro lens 18 and its drain is connected to the metal 12a with a connection 23.

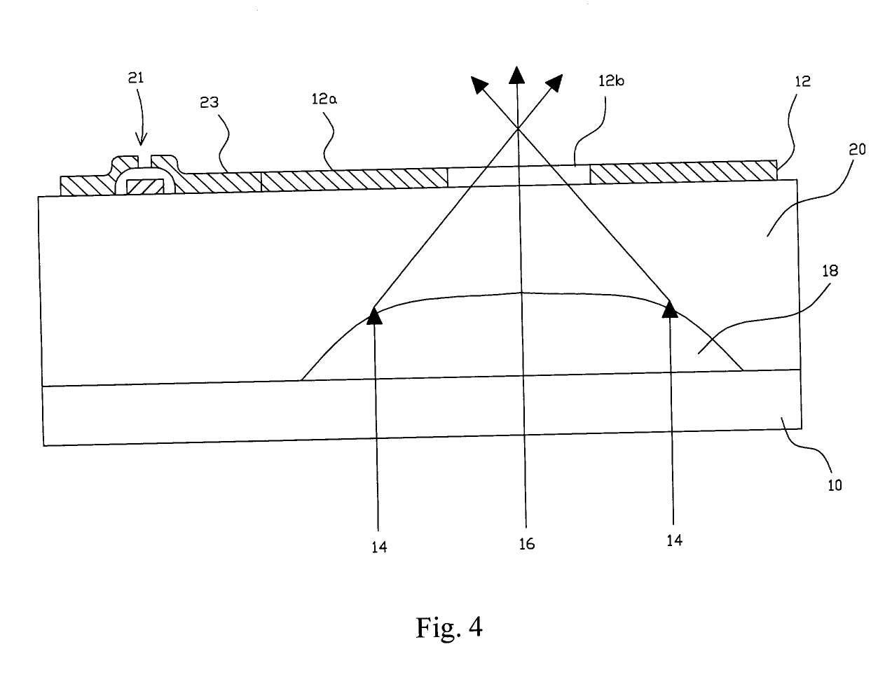

FIG. 4 shows another embodiment arrangement of a TFT for the transflector of FIG. 2. The TFT 21 is alternatively formed on the over coating 20 and its drain is connected to the metal 12a with a connection 23 that may be formed with the same metal layer for the transflector 12.

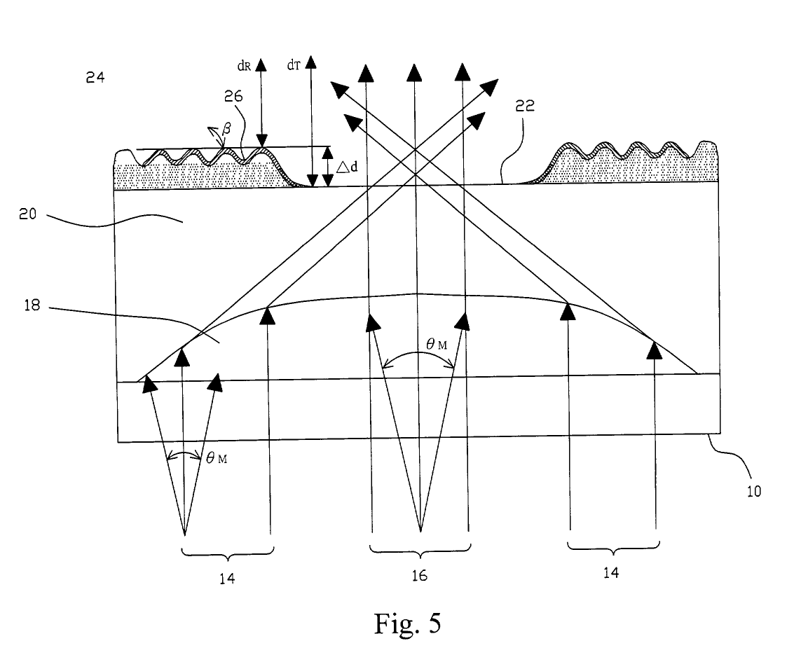

FIG. 5 shows the second embodiment transflector according to the present invention with an inner diffusive reflector (IDR) structure. Similarly to the arrangement of FIG. 2, on the substrate 10 there is a micro lens 18 and an over coating 20, while the transmissive region 22 is formed on the over coating 20 with a deposited indium tin oxide (ITO), indium zinc oxide (IZO), or the material with a transmissivity of more than 20% such as thin aluminum (Al), silver (Ag) and their alloy. An insulator 24 is deposited on the over coating 20, and a reflective layer 26, such as Al, Ag and their alloy, is deposited on the insulator 24. To form a roughness on the surface of the reflective layer 26 for scaterring, the insulator 24 is formed with a scraggly topology. Due to the thickness of the insulator 24, the average cell gap d_{T} of the transmissive region 22 is greater than the average cell gap d_{R} of the reflective layer 26, and in this embodiment Δd is 0.15-3 μm where Δd=d_{T}−d_{R}. The average undulate angle β of the reflective layer 26 in the IDR structure is 2-20 degrees. The backlight 14 and 16 from the backlight source to the panel have a divergent angle θ_{M}, preferably in the arrange of 0-35 degrees for better display performance.

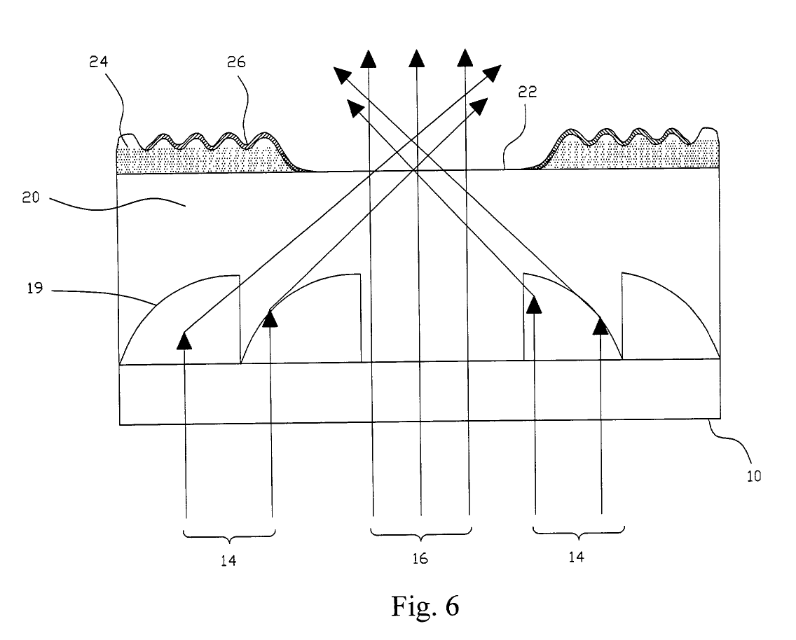

FIG. 6 shows the third embodiment transflector according to the present invention with an inner diffusive reflector (IDR) structure, in which the optical arrangement is similar to that of FIG. 3 except that a plurality of micro prisms 19 are alternatively employed and may be arranged to be an array with a period. It is noted that other optical micro apparatus, such as hologram grating, may be selected for the transflector to gather the backlights even micro lens and micro prism are designed hereinwith for examplariry embodiments.

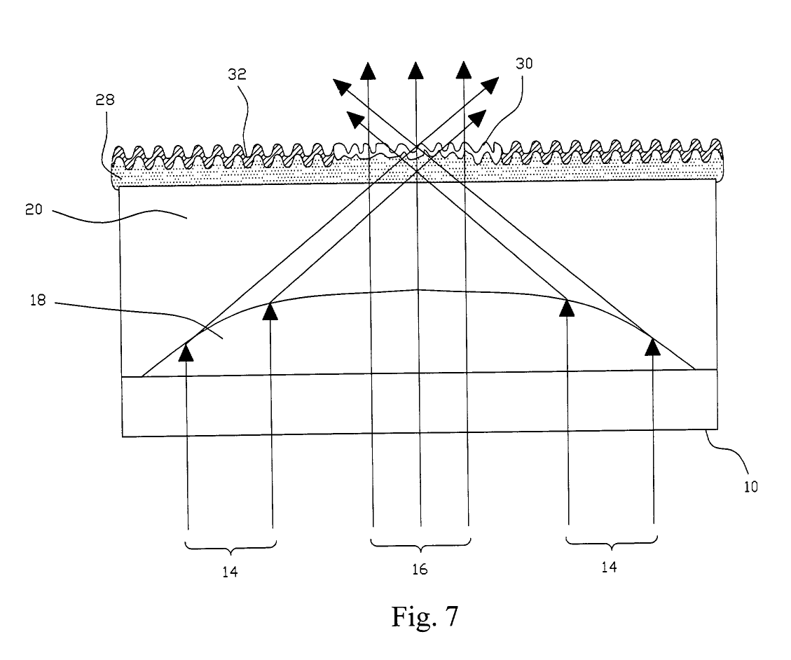

The fourth embodiment transflector is shown in FIG. 7, in which the IDR structure is still employed, while the transmissive region 30 and the reflective layer 32 are both formed on the insulator 28 such that the cell picth d_{T} and d_{R} between the transmissive region 30 and the reflective layer 32 are equal.

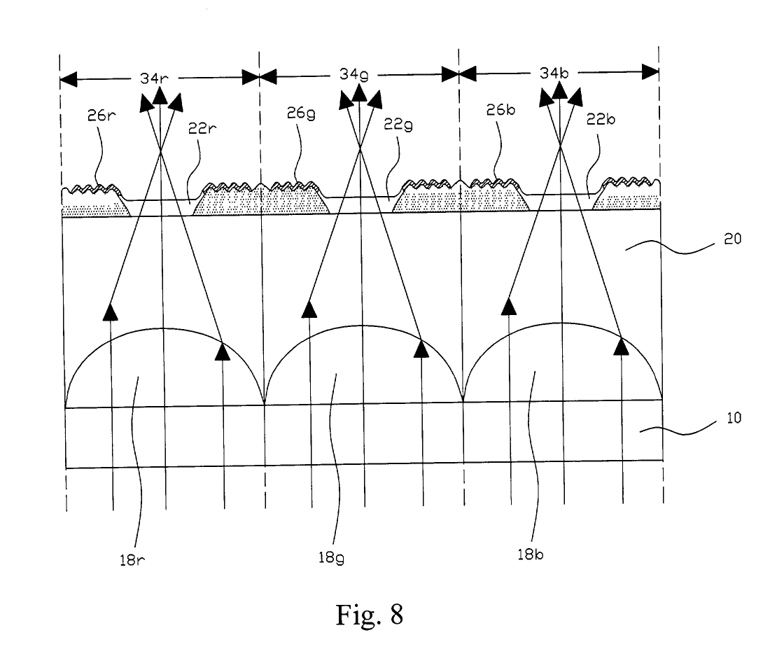

FIG. 8 is the embodiment transflector applied in a color LCD, in which a color pixel cell 34 has three liquid crystal cells 34r, 34g and 34b for red, green and blue, respectively. Each liquid crystal cell 34r, 34g or 34b has a respective transmissive region 22r, 22g and 22b formed on the over coating 20 corresponding to the micro lens 18r, 18g and 18b on the substrate 10, respectively. The micro lens 18r, 18g and 18b are made of color filtering material so as to be also serving as the color filter of the pixel.

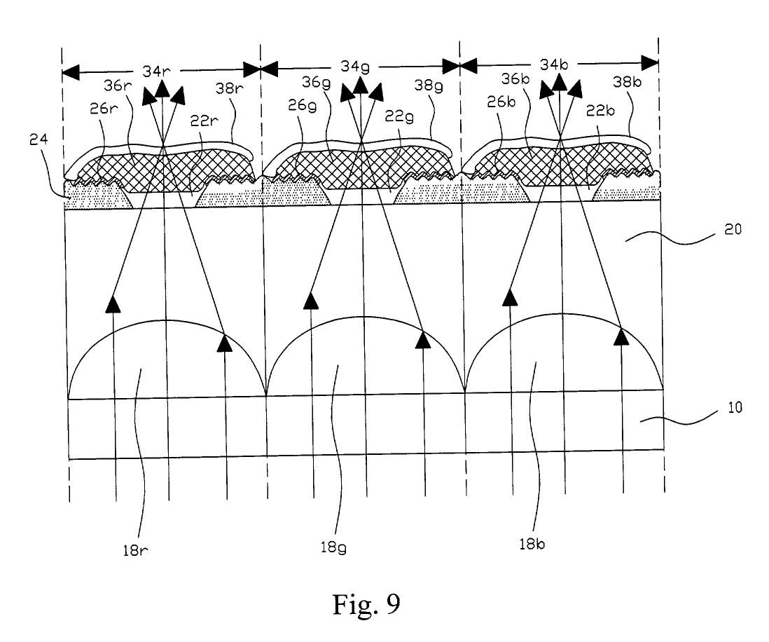

FIG. 9 is another embodiment transflector applied in a color LCD. Similarly, a pixel cell has three liquid crystal cells 34r, 34g and 34b with the same structure as that in FIG. 3 except that respective color filters 36r, 36g and 36b are formed on the transmissive regions 22r, 22g and 22b and above is deposited with transparent electrodes 38r, 38g and 38b, such as ITO. The micro lens 18r, 18g and 18b are transparent, instead of color dependent.

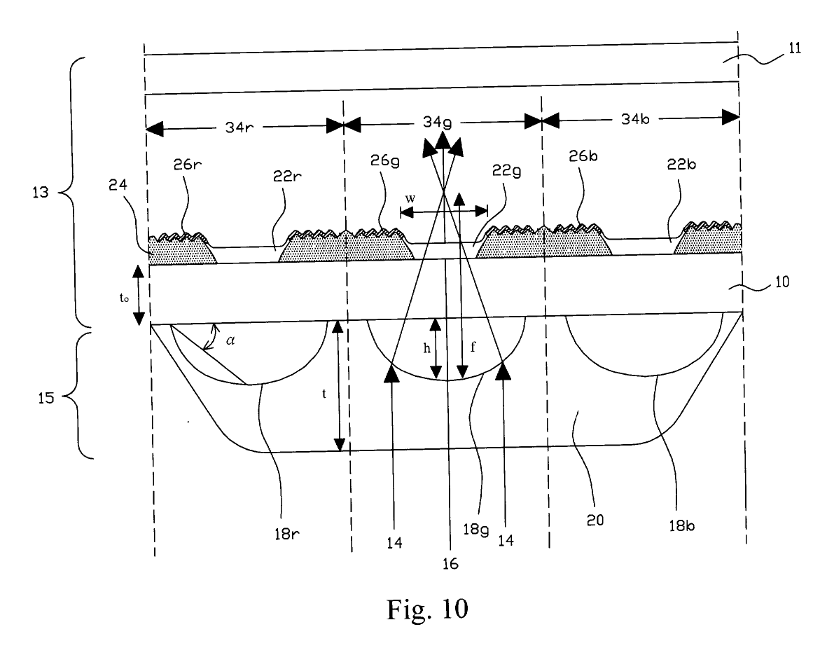

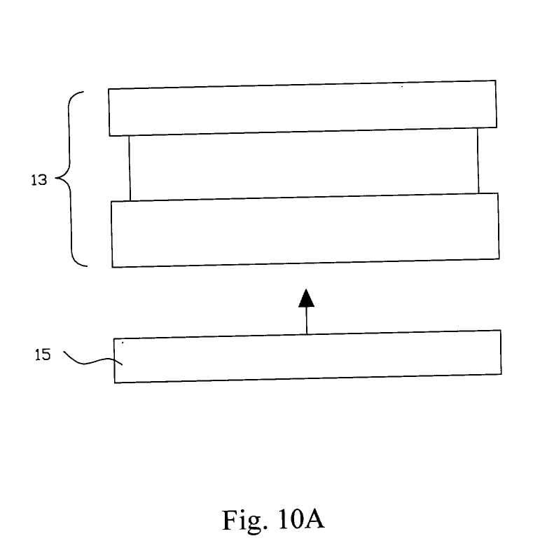

FIG. 10 is an embodiment transflector with another micro lens arrangement. The transmissive region 22r, 22g and 22b of a color LCD are formed on the substrate 10 whose rear side is formed with the micro lens 18r, 18g and 18b and further covered with the over coating 20. The thickness of the substrate 10 is t₀, the height h in the middle of the micro lens 18 is 0.3-5 μm, the average elevation angle α from the edge to the central top surface of the micro lens 18 is 0.5-8 degrees, and the average focus length f of the micro lens 18 is 250-700 μm. Typically, it is called LCD cell, as referred with number 13 in FIG. 10, from the bottom plate 10 to the top plate 11 including the liquid crystal and related means therebetween, and thus the optical apparatus referred with number 15 including the micro lens 18 and over coating 20 to gather the backlight to the transmissive regions 22 is arranged outside the LCD cell 13, which may be a film or plate attached to the LCD cell 13 as shown in FIG. 10A. As aforementioned, the optical apparatus 15 to gather the backlight to the transmissive regions may alternatively be a hologram plate including a plurality of hologram pattern as grating to gather the backlight to the transmissive regions of the LCD cell 13.

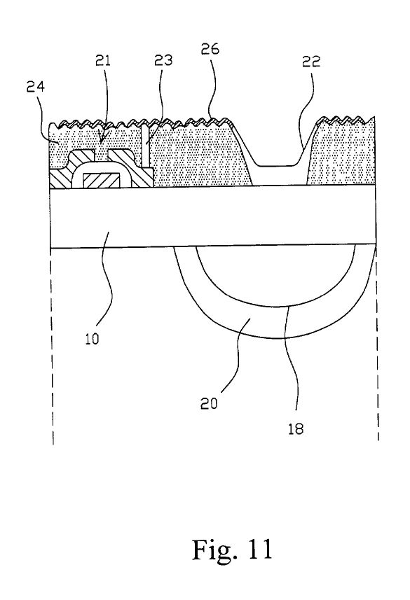

FIG. 11 shows an embodiment arrangement of a TFT for the transflector of FIG. 10, in which the TFT 21 is formed on the substrate 10 and covered by the over coating 28 and its drain is connected to the metal 26 with a connection 23.

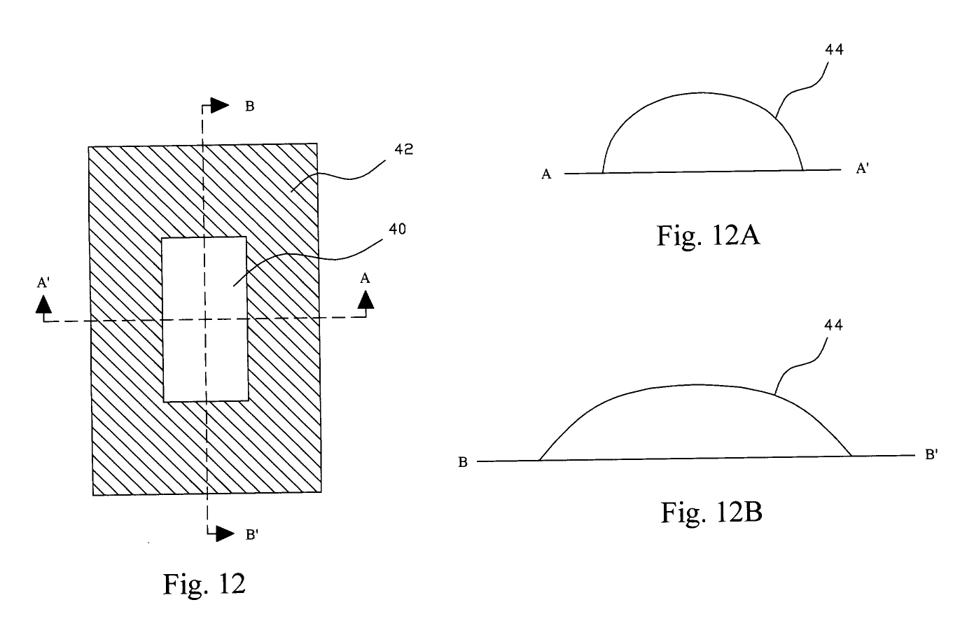

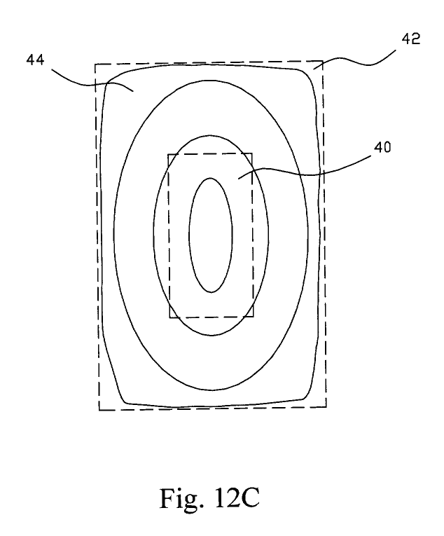

FIG. 12 is the top view of a transflector in a liquid crystal cell, in which the transmissive region 40 is arranged near the center of the reflective region 42. As the profile of FIGS. 12A and 12B sectioned with two crossover lines AA′ and BB′, the micro lens 44 is a long and narrow hill, and its contour map is shown in FIG. 12C.

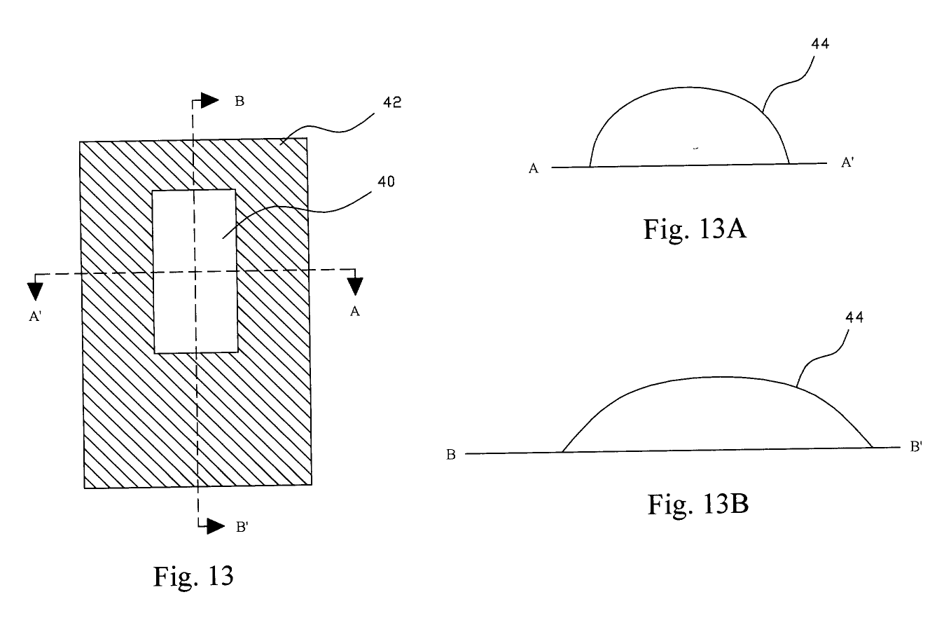

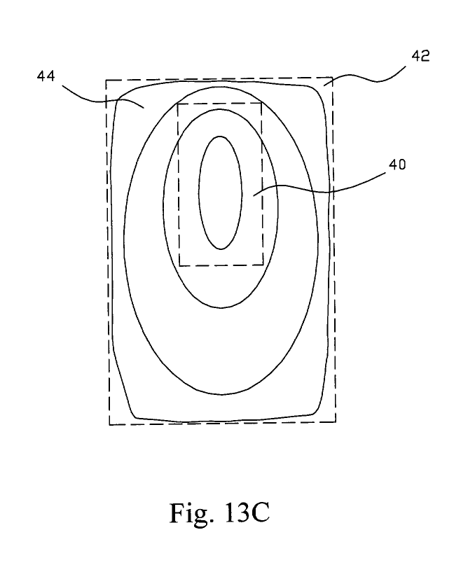

FIG. 13 is the top view of another transflector in a liquid crystal cell, in which the transmissive region 40 deviates from the center of the reflective region 42. As the profile of FIGS. 13A and 13B sectioned with two crossover lines AA′ and BB′, the micro lens 44 is a bias hill, and its contour map is shown in FIG. 13C.

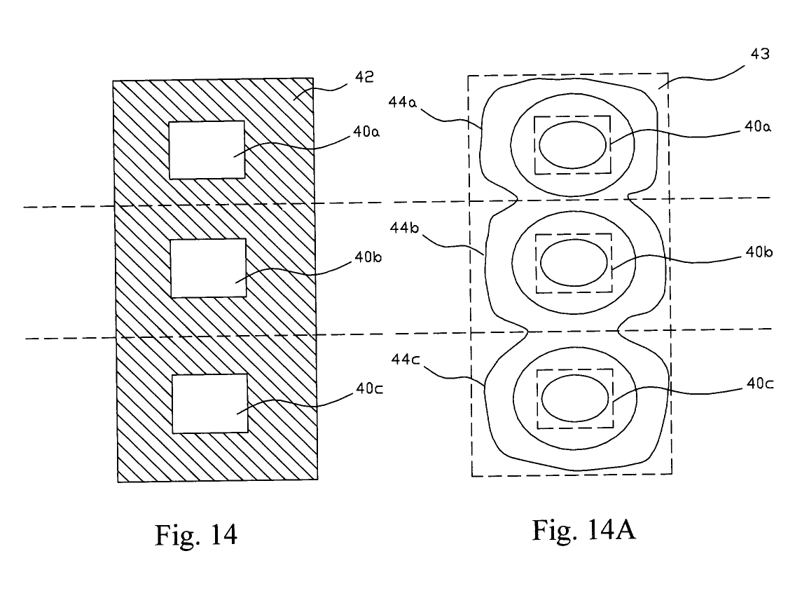

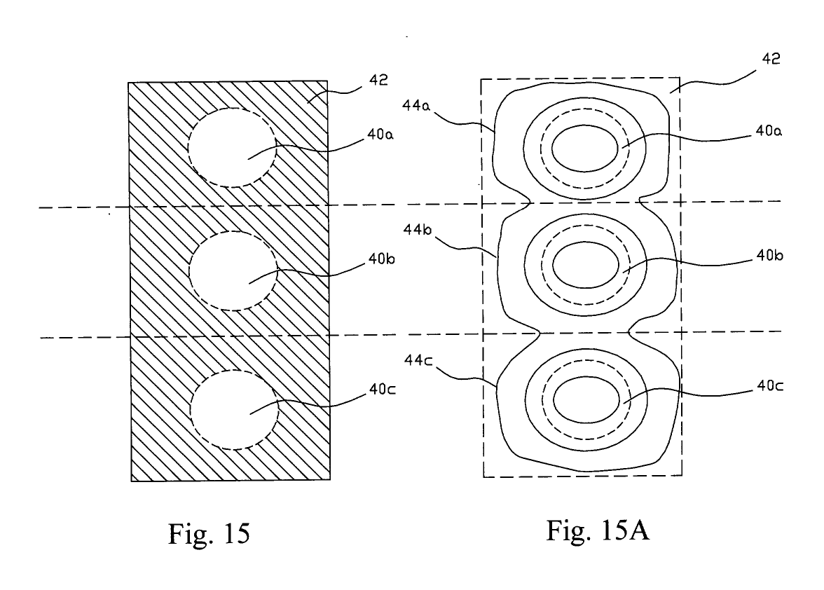

FIG. 14 is the top view of yet another transflector in a liquid crystal cell, in which the transmissive region 40 includes three rectangle sub-regions 40a, 40b and 40c. FIG. 11A shows the contour map of the micro lens 44 that comprises three micro lens sub-structures 44a, 44b and 44c corresponding to the three sub-regions 40a, 40b and 40c, respectively.

FIG. 15 is the top view of further another transflector in a liquid crystal cell, and FIG. 15A shows the contour map of the micro lens 44. This embodiment structure is similar to that of FIG. 14 except that three sub-regions 40a, 40b and 40c of the transmissive region 40 are substantially circle.

In other embodiments, the micro lens can be formed by stacked multi-layer materials each layer with same or different refractive index, the shape of the transmissive region can be changed, and the area ratio of transmissive region to reflective region is 5-400%. With the same type of LCD, the gain of light efficiency according to the present invention is 120-400% or more. Moreover, since the efficiency of the backlight is improved, the reflective region can be enlarged by increasing its area ratio, thereby the display performance in the reflective display mode can also be improved. If the material of the micro lens is chosen with a transmissivity more than 70% for the light wavelength of 400 nm, the LCD will have a better color performance.

In these embodiments, if positive type of liquid crystal (dielectric anisotropy Δε>0) is selected for the LCD, preferably, An (the difference between the refractive indexes no and ne of ordinary and exta-ordinary light) is 0.05-0.095, Δnd_{T} is 280-460 nm, and Δnd_{R} is 200-320 nm, and if negative type of liquid crystal (Δε<0) is selected for the LCD, then Δn is 0.06-0.12, Δnd_{T} is 320-480 nm, and Δnd_{R} is 150-360 nm.

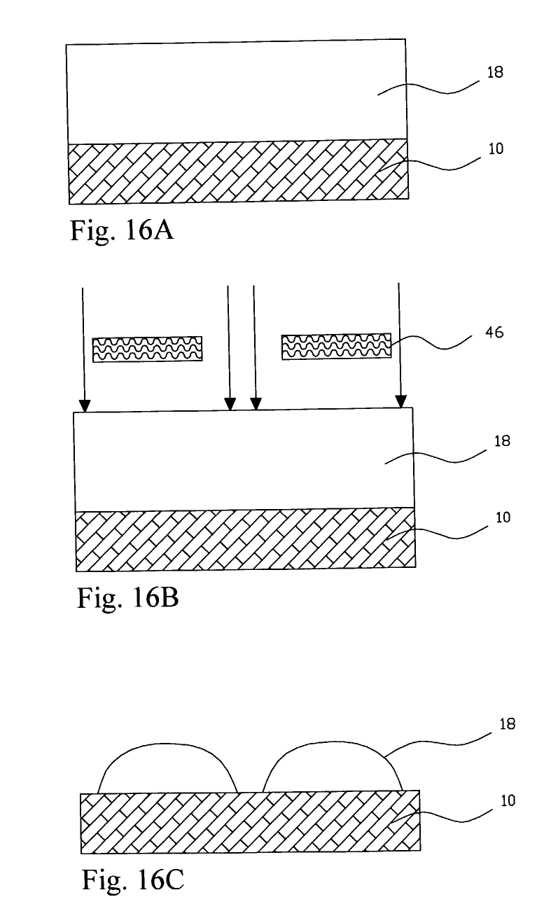

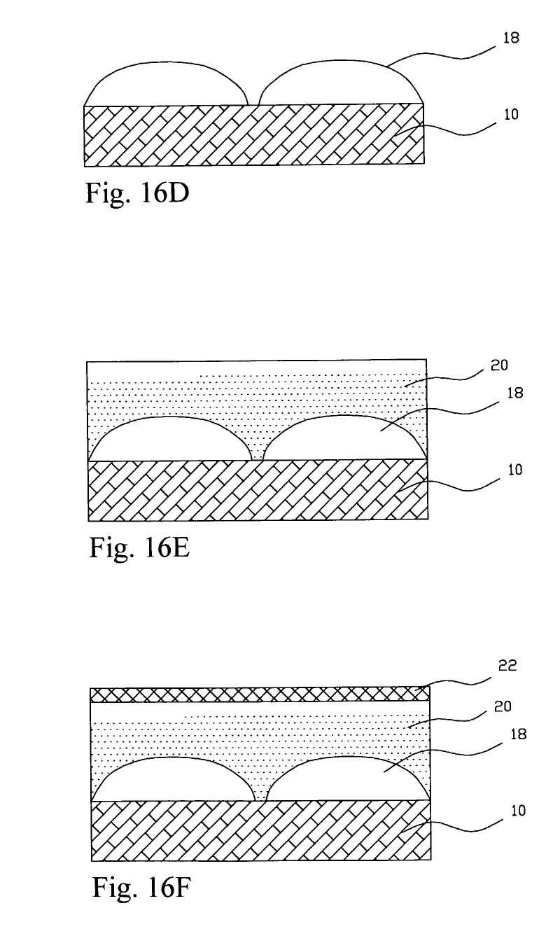

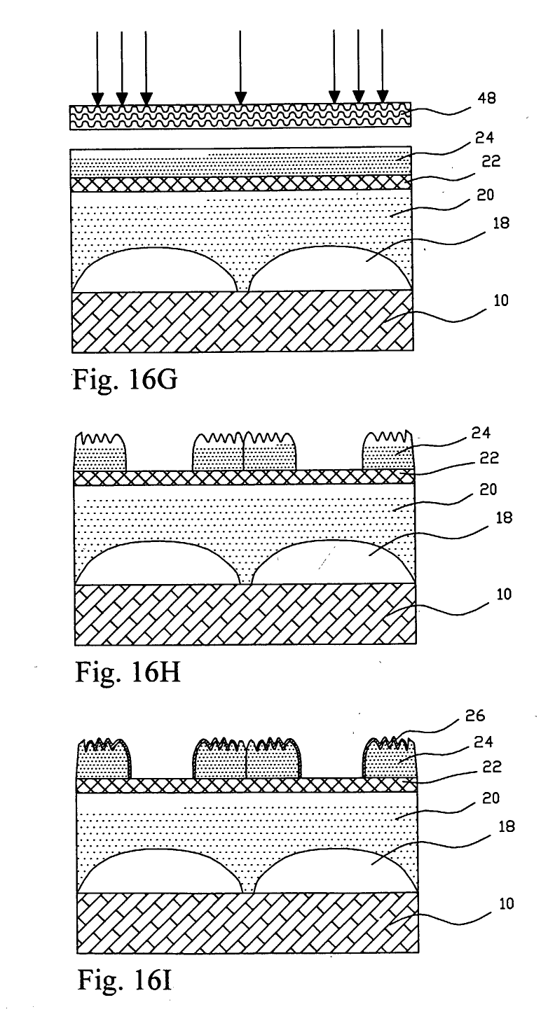

FIG. 16 is an embodiment process for manufacturing the micro lens of FIG. 5. As shown in FIG. 16A, the substrate 10 is coated with a positive photoresistor 18, for example, the MFR series, PC series or NN series of JSR company product. The steps of coating the photo-resistor 18 include rotating in 300 rpm for 3 seconds, then rotating in 800 rpm for 30 seconds, and pre-baking in 60-120° C. for 2-10 minutes. In FIG. 16B, the pattern of the micro lens is transferred to the photoresistor 18 with mask 46, exposing in 200-600 mJ/cm², developing with surfacants developer solution TMAH and rinsing with water for 60 seconds, and proceeding the post exposing in 200-600 mJ/cm². The micro lens 18 thus formed is shown in FIG. 16C. After middle baking 2-15 minutes in 80-180° C. to soften the micro lens 18, the resultant structure is shown in FIG. 16D. Further, hard baking 30-60 minutes in about 200° C. and depositing an over coating 20 on the micro lens 18, the resultant structure is shown in FIG. 16E. In FIG. 16F, ITO 22 is deposited on the over coating 20, and then a positive photoresistor 24 is further coated, as shown in FIG. 16G, followed with transferring and developing the pattern of diffusive layer with mask 48 to form the resultant structure showed in FIG. 16H. As shown in FIG. 161, a reflective layer 26 is selectively formed on the diffusive layer 24.

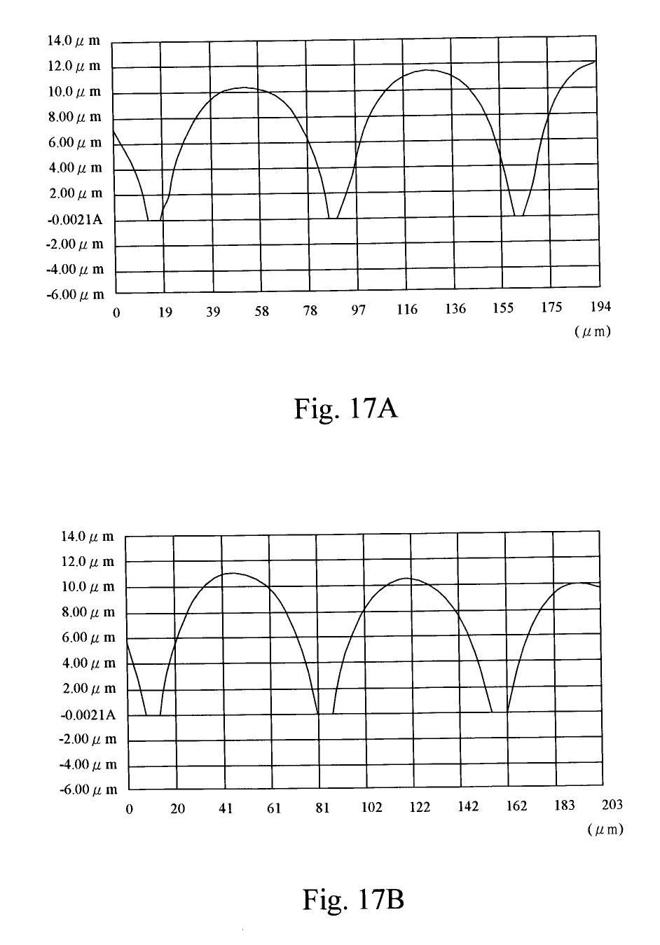

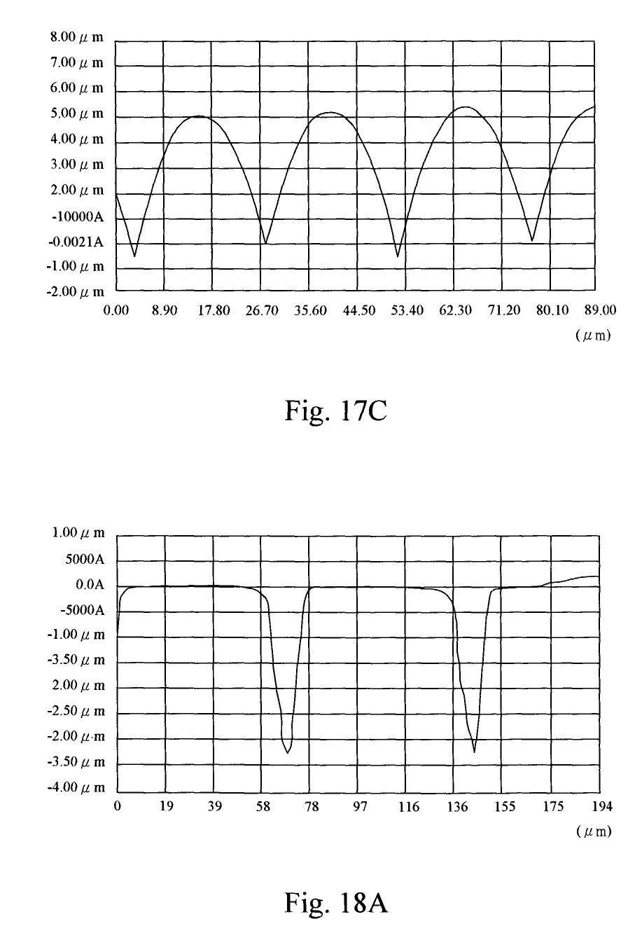

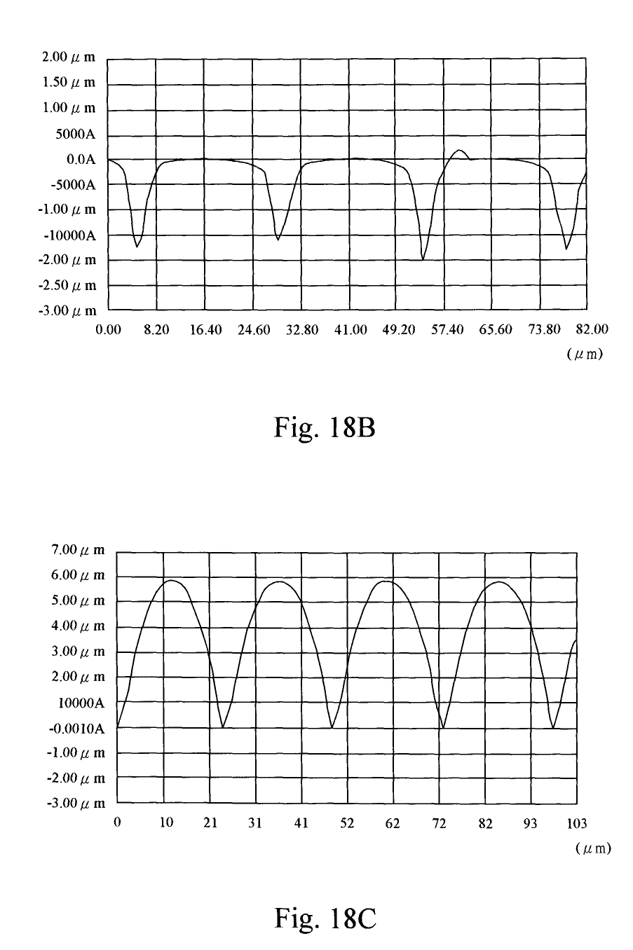

FIGS. 17 and 18 are the scanned profile of the micro lens 18 formed by the process of FIG. 16 in different gradation. The widths of the micro lens 18 in this embodiment in X and Y directions are 21 and 63 μm, respectively, and the spaces between adjacant micro lens in X and Y directions are 4 and 12 μm, respectively. FIGS. 17A and 18A are the profiles of the micro lens 18 in X and Y directions, respectively, before the middle baking, FIGS. 17B and 18B are the profiles of the micro lens in X and Y directions, respectively, after the middle baking, and FIGS. 17C and 18C are the profiles of the micro lens in X and Y directions, respectively, after the hard baking.

The inventive transflector, method thereof, and process to form the transflector can be applied to various types of LCDs, such a-Si TFT LCD, poly-Si TFT LCD, thin film diode (TFD) LCD, and passive matrix super twisted nematic (STN) LCD.

From the above, it should be understood that the embodiments described, in regard to the drawings, are merely exemplary and that a person skilled in the art may make variations and modifications to the shown embodiments without departing from the spirit and scope of the present invention. All variations and modifications are intended to be included within the scope of the present invention as defined in the appended claims.

What is claimed is:

1. A transflective LCD comprising:
a bottom plate corresponding to a plurality of switching elements;
an upper plate facing to the bottom plate;
a layer of liquid crystal inserted between the upper plate and the bottom plate; and
a transflector with a high gain of light efficiency arranged on the bottom plate side, the transflector including a reflective region to reflect a frontlight and a transmissive region to permit a backlight passing through with a micro optical apparatus for gathering the backlight to the transmissive region.

2. The LCD of claim 1, wherein the liquid crystal is a positive type of liquid crystal with a birefringence Δn of 0.05-0.095, a retardation Δnd_{T} of 280-460 nm and Δnd_{R} of 200-320 nm where Δn=nₑ−nₒ, nₒ is a refractive index of ordinary light, n^{e} is a refractive index of exta-ordinary light, d_{T} is an average cell gap of the transmissive region, and d_{R} is an average cell gap of the reflective region.

3. The LCD of claim 1, wherein the liquid crystal is a negative type of liquid crystal with a birefringence Δn of 0.06-0.12, a retardation Δnd_{T} of 320-480 nm and Δnd_{R} of 150-360 nm where Δn=nₑ−nₒ, nₒ is a refractive index of ordinary light, ne is a refractive index of exta-ordinary light, d_{T} is an average cell gap of the transmissive region, and d_{R} is an average cell gap of the reflective region.

4. The LCD of claim 1, further comprising an over coating covered on the micro optical apparatus.

5. The LCD of claim 4, wherein the micro optical apparatus has a first refractive index n₁ of 1.4-2.5 and the over coating has a second refractive index n₂ with |n₁−n₂|≧0.02.

6. The LCD of claim 4, wherein the micro optical apparatus is arranged between the bottom plate and the thansflector.

7. The LCD of claim 6, wherein the micro optical apparatus has a width l and a height h of 2-10 μm in a middle of the micro optical apparatus to have h/l of 0.02-0.3.

8. The LCD of claim 6, wherein the micro optical apparatus has an average elevation angle of 1-2.5 degrees from an edge to a central top surface of the micro optical apparatus.

9. The LCD of claim 6, wherein the micro optical apparatus has an average focus length f, and the over coating has a thickness of 2-16 μm to have f/t of 0.8-1.3.

10. The LCD of claim 6, wherein at least one of the plurality of switching elements is coverd by the over coating and connected to the reflective region.

11. The LCD of claim 6, wherein at least one of the plurality of switching elements is formed on the over coating and connected to the reflective region.

12. The LCD of claim 4, wherein the bottom plate is arranged between the micro optical apparatus and the transflector.

13. The LCD of claim 12, wherein the micro optical apparatus has a height of 0.3-5 μm in a middle of the micro optical apparatus.

14. The LCD of claim 12, wherein the micro optical apparatus has an average elevation angle of 0.5-8 degrees from an edge to a central top surface of the micro optical apparatus.

15. The LCD of claim 12, wherein the micro optical apparatus has an average focus length of 250-700 μm.

16. The LCD of claim 12, wherein at least one of the plurality of switching elements is formed on the bottom plate and connected to the reflective region.

17. The LCD of claim 1, wherein the reflective region has an inner diffusive reflector structure.

18. The LCD of claim 17, wherein the transmissive region has a first average cell gap, and the reflective region has a second average cell gap not greater than the first average cell gap.

19. The LCD of claim 18, wherein the first and second average cell gaps have a difference of 0.15-3 μm.

20. The LCD of claim 19, wherein the reflective region has a rough surface with an undulate average angle of 2-20 degrees.

21. The LCD of claim 1, wherein the micro optical apparatus comprises at least a micro lens.

22. The LCD of claim 1, wherein the micro optical apparatus comprises a micro prism array.

23. The LCD of claim 1, wherein the micro optical apparatus comprises at least a hologram grating.

24. The LCD of claim 1, wherein the backlight has a divergent angle of 0-35 degrees.

25. The LCD of claim 1, wherein the micro optical apparatus has a tranmissivity not less than 70% for a light wavelength of 400 nm.

26. The LCD of claim 1, wherein the micro optical apparatus is a color filter.

27. The LCD of claim 1, further comprising:
a color filter on the transmissive region; and
a transparent electrode on the color filter.

28. The LCD of claim 1, wherein the transmissive region includes a plurality of sub-regions.

29. The LCD of claim 1, wherein the transmissive region is subtatially in a center of the reflective region.

30. The LCD of claim 1, wherein the transmissive region deviates a center of the reflective region.

31. The LCD of claim 1, wherein the transmissive region and the reflective region have an area ratio of 5-400%.

32. The LCD of claim 1, wherein the transmissive region substantially has a shape of a rectangle.

33. The LCD of claim 1, wherein the transmissive region substantially has a shape of a circle or ellipsoid.

34. A method for improving a gain of light efficiency for an LCD, comprising the steps of:
providing a transflector having a reflective region to reflect a frontlight and a transmissive region to permit a backlight to pass through the transflector; and
gathering the backlight to the transmissive region by a micro optical apparatus.

35. The method of claim 34, further comprising filtering the backlight by the micro optical apparatus.

36. The method of claim 34, further filtering the backlight passing through the transmissive region with a filter.

37. A method for forming a transflector with a high gain of light efficiency for an LCD, comprising the steps of:
coating a photoresistor on a substrate;
exposing and developing the photoresistor to form a micro optical apparatus;
depositing an over coating on the micro optical apparatus; and
forming a transmissive region and a reflective region above the over coating.

38. The method of claim 37, further comprising pre-baking the photoresistor 2-10 minutes in 60-120° C.

39. The method of claim 37, further comprising baking the micro optical apparatus 2-15 minutes in 80-180° C.

40. The method of claim 37, further comprising hard baking the micro optical apparatus 30-60 minutes in 200° C.

41. The method of claim 37, wherein the step of forming the transmissive region and reflective region comprises the steps of:
depositing a transparent material with a transmissivity more than 20% on the over coating;
coating a second photoresistor on the transparent material;
exposing and developing the second photoresistor to form a diffusive layer; and
selectively forming a reflective material on the diffusive layer.

42. The method of claim 41, wherein the transparent material is selected from the group composed of ITO, IZO, and thin Al, Ag, and alloy of Al and Ag.

43. The method of claim 41, wherein the transparent material is selected from the group composed of Al, Ag and alloy of Al and Ag.
